(19) United States
(12) Patent Application Publication
(10) Pub. No.: US 2019/0018468 A1
(43) Pub. Date: Jan. 17, 2019

(54) MEMORY CHIP, MEMORY DEVICE AND MEMORY SYSTEM COMPRISING SAME DEVICE

(71) Applicant: TSP GLOBAL, CO., LTD., Hwaseong-si, Gyeonggi-do (KR)

(72) Inventors: Sangseok KANG, Suwon-si (KR); Chang-Zoo CHOI, Uiwang-si (KR); Sun-Young LEE, Uiwang-si (KR); Jin-seok LEE, Youngin-si (KR)

(73) Assignee: TSP GLOBAL, CO., LTD., Hwaseong-si, Gyeonggi-do (KR)

(21) Appl. No.: 16/070,851

(22) PCT Filed: Jan. 20, 2017
(86) PCT No.: PCT/KR2017/000726

§ 371 Date: Jul. 18, 2018

(30) Foreign Application Priority Data
Feb. 3, 2016 (KR) 10-2016-0013274

(51) Int. Cl. G06F 1/26; G06F 13/16; G06F 3/06

(52) U.S. Cl. CPC G06F 1/266; G06F 13/1668; G06F 3/0679; G06F 3/0659; G06F 3/061

(57) ABSTRACT

The present application relates to a memory chip in which a power voltage is independently supplied to a memory cell array and a peripheral circuit, a memory device and a memory system comprising the same device. A memory device according to an embodiment of the present invention comprises: at least one memory chip comprising a memory cell array consisting of an array of memory cells and a peripheral circuit which is positioned around the memory cell array and in which a power line electrically independent from the memory cell array is formed; and a power voltage supply for supplying a power voltage to the memory cell array and the peripheral circuit, wherein the power voltage supply independently supplies the power voltage to each of the memory cell array and the peripheral circuit.

### TECHNICAL FIELD

The present invention relates to a memory chip, in which a power voltage is independently supplied to a memory cell array and a peripheral circuit, and a memory device and a memory system including the same device.

### BACKGROUND ART

As memory technology advances, memory devices are becoming more integrated and performance improvement thereof is required, and to this end, a design of a memory chip is improved to reduce a size thereof. Development of a memory chip capable of operating more rapidly with the same power is becoming necessary.

Conventionally, a single power voltage is supplied from the outside of a memory chip, and a memory cell array power voltage VDDA and a peripheral circuit power voltage VDDP are generated through a separate internal power voltage generating circuit in the memory chip. FIG. 1 is a diagram illustrating a configuration of a conventional memory device, and FIG. 2 is a diagram illustrating a configuration of a conventional memory chip. As shown in FIG. 1, the conventional memory device supplies a single power voltage to a memory chip, and as shown in FIG. 2, the conventional memory chip includes a separate internal voltage generating circuit to generate a power voltage which will be supplied to a memory cell array and a peripheral circuit. When a power voltage VDDA for the memory cell array and a power voltage VDDP for the peripheral circuit are generated inside the memory chip, the power voltages are fixed to a single voltage regardless of types of applied products such as high-speed products or low-power consumption products so that differentiated products may not be implemented from the perspective of customers who use memories.

However, when the power voltage VDDA (an array VDD) supplied to the memory cell array is lowered, a current consumed in the memory cell array may be significantly reduced, and the power voltage VDDP (a periphery VDD) supplied to the peripheral circuit is increased, an operation speed of the memory device may be increased so that in order to improve the performance of the memory device, it is necessary to supply the power voltage for the memory cell array and the power voltage for the peripheral circuit separately from the outside of the memory chip.

In this regard, although Korean Patent Laid-Open Application No. 10-2004-0000880 (entitled “Method for supplying power supply voltage in semiconductor memory device and circuit for supplying cell array power supply voltage”) has been registered, there is a limitation of the conventional technique in that a power voltage cannot be independently supplied to a memory cell array and a peripheral circuit.

### DISCLOSURE

### Technical Problem

The present invention is directed to providing a memory chip in which a power voltage is independently supplied to a memory cell array and a peripheral circuit, a memory device, and a memory system including the memory device.

### Technical Solution

One aspect of the present invention provides a memory chip includes a memory cell array configured with an arrangement of memory cells, and a peripheral circuit positioned around the memory cell array and having a power line electrically independent from the memory cell array, wherein a power voltage is independently and externally supplied to the memory cell array and the peripheral circuit.

Another aspect of the present invention provides a memory device including at least one memory chip which includes a memory cell array configured with an arrangement of memory cells and a peripheral circuit positioned around the memory cell array and having a power line electrically independent from the memory cell array, and a power voltage supply unit configured to supply a power voltage to the memory cell array and the peripheral circuit, wherein the power voltage supply unit independently supplies the power voltage to the memory cell array and the peripheral circuit.

Still another aspect of the present invention provides a memory system including a memory device which includes at least one memory chip having a memory cell array configured with an arrangement of memory cells and a peripheral circuit positioned around the memory cell array and having a power line electrically independent from the memory cell array, and a power voltage supply unit configured to supply a power voltage to the memory cell array and the peripheral circuit, wherein the power supply voltages are independently and externally supplied to the memory cell array and the peripheral circuit, a memory controller configured to control a command, a piece of data, and an address which are input to and output from the memory device, and a memory bus configured to transfer information between the memory device and the memory controller.

Therefore, the present invention may provide a memory cell array power voltage (VDDA) and a peripheral circuit power voltage (VDDP), which are desired by a customer according to application, by externally separating and providing the memory cell array power voltage (VDDA) and the peripheral circuit power voltage (VDDP).

Additionally, the above-described solutions are not all of the features of the present invention. Various features of the present invention and advantages and effects thereof will be more fully understood by reference to the following Modes of the Invention.

### Advantageous Effects

In accordance with one embodiment of the present invention, a memory chip, in which a power voltage required for a memory cell array and a peripheral circuit is generated outside the memory chip and the generated power voltage is independently supplied to the memory cell array and the peripheral circuit, a memory device and a memory system using the same are provided. Therefore, a memory chip operating at high speed, in which a low power voltage is supplied to the memory cell array to significantly reduce current consumption and a high power voltage is also supplied to the peripheral circuit, and a memory device and a memory system using the same can be implemented, and power integrity (PI) and signal integrity (SI) problems due to the lack of power capability can also be resolved.

Further, since the memory chip and the memory device and system using the same according to the embodiments of the present invention do not need to have a power voltage generating circuit in each memory chip so that a size of the memory chip can be reduced such that efficiency in design of the memory chip is achieved, and a memory chip, which is capable of eliminating side effects of heat generated when a power supply voltage is generated inside the memory chip, and a memory device and a memory system using the same can be provided.

### DESCRIPTION OF DRAWINGS

FIG. 1 is a diagram illustrating a configuration of a conventional memory device.

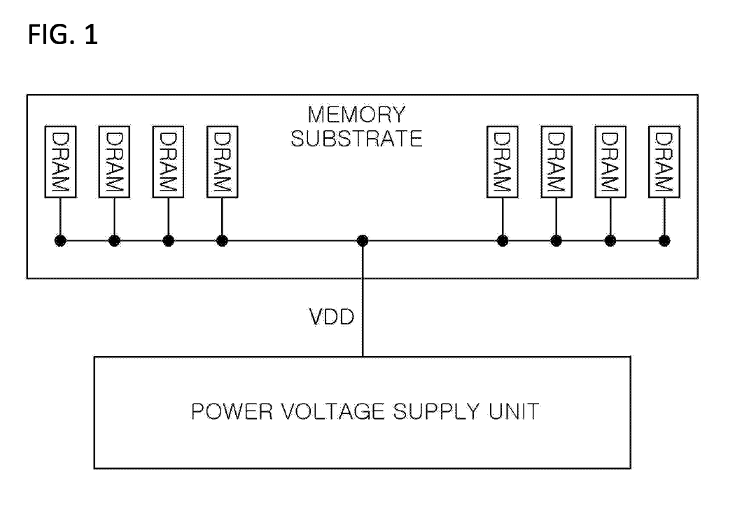

FIG. 2 is a diagram illustrating a configuration of a conventional memory chip.

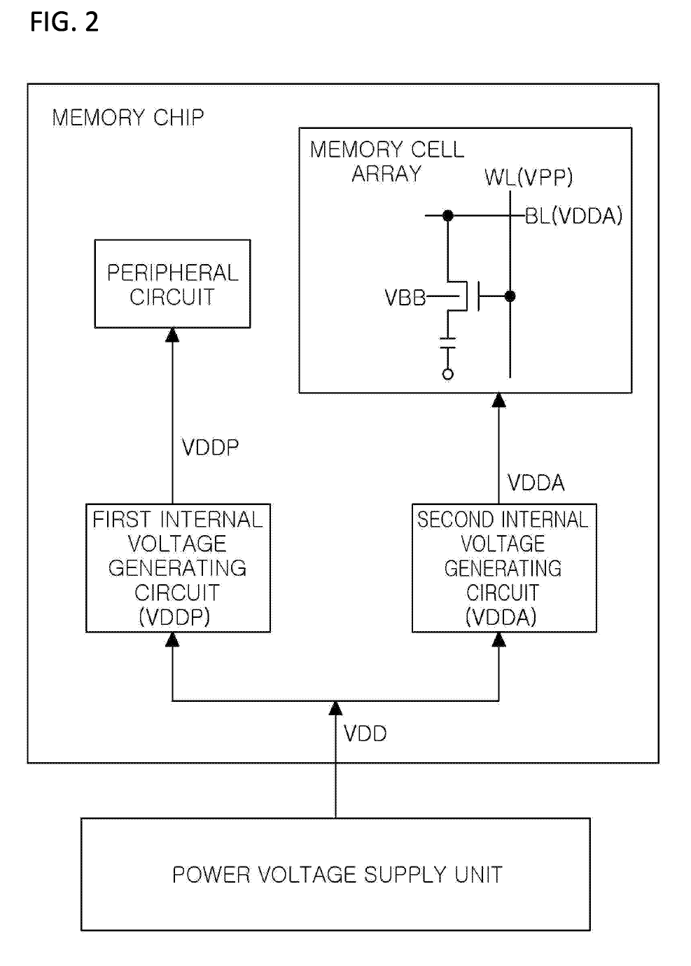

FIG. 3 is a diagram illustrating a configuration of a memory chip according to one embodiment of the present invention.

FIG. 4 is a diagram illustrating a configuration of a memory chip according to another embodiment of the present invention.

FIG. 5 is a diagram illustrating a configuration of a memory device according to one embodiment of the present invention.

FIG. 6 is a diagram illustrating a case in which a power voltage is supplied to the memory chip according to one embodiment of the present invention.

FIG. 7 is a diagram illustrating a configuration of a memory device according to another embodiment of the present invention.

FIG. 8 is a diagram illustrating a configuration of a memory system according to one embodiment of the present invention.

### MODES OF THE INVENTION

Hereinafter, exemplary embodiments of the present invention will be described in detail with reference to the accompanying drawings so as to allow those skilled in the art to which the present invention pertains to easily practice the present invention. Further, in the following detailed description of the present invention, when a detailed description of related known functions or configurations is determined to obscure the gist of the present invention, the detailed description thereof will be omitted. Furthermore, throughout the drawings, the same reference numerals are assigned to parts having similar functions and actions.

Moreover, throughout this disclosure, when a part is referred to as being “connected” to another part, this includes a case in which the part is “directly connected” to another part as well as a case in which the part is “indirectly connected” to another part by interposing a different element between the part and another part. Additionally, when a component is referred to as “being included,” it refers that other components may further be included, not excluding other components unless specifically stated otherwise.

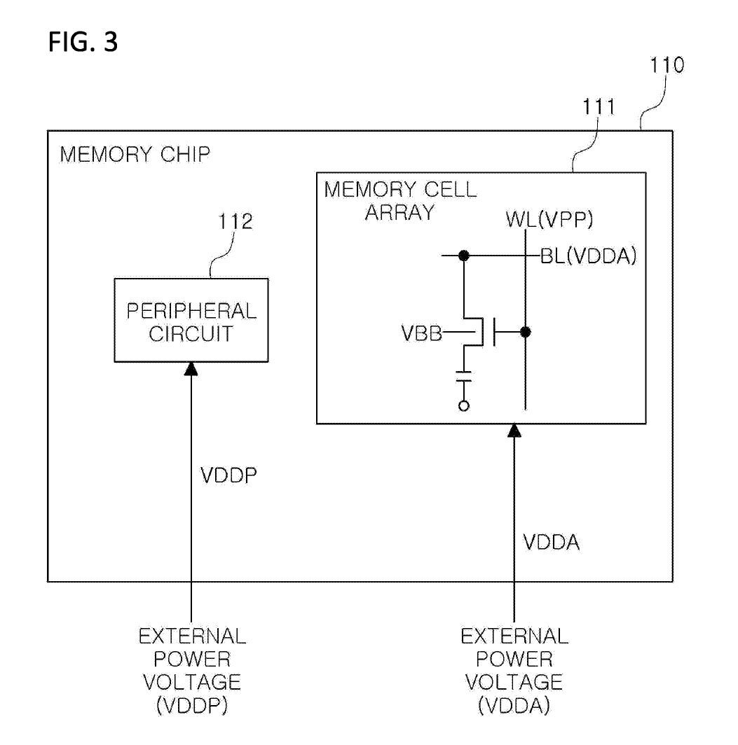

FIG. 3 is a diagram illustrating a configuration of a memory chip according to one embodiment of the present invention. As shown in FIG. 3, a memory chip 110 according to one embodiment of the present invention may include a memory cell array 111 and a peripheral circuit 112.

Here, the memory chip 110 may be a dynamic random access memory (DRAM) or a flash memory, and the memory chip 110 may be disposed at both sides of a semiconductor substrate to constitute a dual in-line memory module (DIMM).

The memory cell array 111 may be configured with an arrangement of memory cells, and the peripheral circuit 112 may be positioned around the memory cell array 111 and may include elements or circuits required for driving the memory chip in addition to the memory cells.

Meanwhile, a power line for receiving a power voltage may be formed at each of the memory cell array 111 and the peripheral circuit 112, and the power line of the memory cell array 111 and the power line of the peripheral circuit 112 may be electrically independently formed from each other. As shown in FIG. 3, the electrical independence means that the power line of the memory cell array 111 is directly connected to a separate device (an “external power voltage” shown in FIG. 3) from which a power voltage is externally supplied, thereby receiving a power voltage supplied from the outside, and in the process of receiving the power voltage, the power line of the memory cell array 111 is not affected by the peripheral circuit 112 and a power voltage supplied to the peripheral circuit 112, and the peripheral circuit 112 is also the same as the memory cell array 111. Accordingly, a power voltage supply unit may include an external power supply for a memory cell array, which is configured to supply a power voltage to the memory cell array 111, and an external power supply for a peripheral circuit, which is configured to supply a power voltage to the peripheral circuit, and thus the power voltage supply unit may independently supply the power voltages to the memory cell array 111 and the peripheral circuit 112.

The memory cell array 111 and the peripheral circuit 112 may independently receive the power voltages from the outside of the memory chip 110, and, at this point, power voltages at different levels may be supplied to the memory cell array 111 and the peripheral circuit 112.

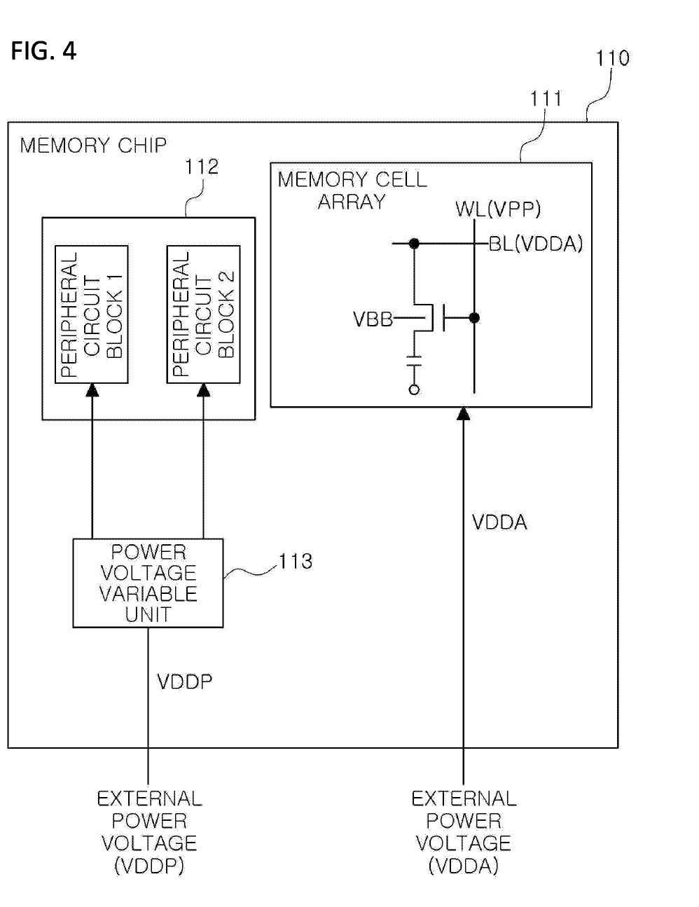

FIG. 4 is a diagram illustrating a configuration of a memory chip according to another embodiment of the present invention. The peripheral circuit 112 may utilize a single power voltage or power voltages at various levels according to an arrangement of internal circuits or devices. Therefore, as shown in FIG. 4, the peripheral circuit 112 may be divided into one or more blocks according to a level of a power voltage used in the peripheral circuit 112.

Further, as shown in FIG. 4, a memory chip according to another embodiment of the present invention may be connected to a peripheral circuit so as to supply a plurality of power voltages to the peripheral circuit having a plurality of blocks as described above, and the memory chip may further include a variable peripheral circuit power voltage unit 113 configured to adjust all or a portion of a power voltage supplied from the outside and supply a plurality of power voltages to the peripheral circuit.

That is, the peripheral circuit 112 of the memory device according to one embodiment of the present invention may adjust the power voltage for the peripheral circuit, which is supplied from the outside, through the variable peripheral circuit power voltage unit 113 so as to supply the power voltage to each of a plurality of peripheral circuit blocks.

For example, when the power voltage supplied to the peripheral circuit from the outside is 1.5 V and blocks using voltages of 1.0 V and 1.5 V are present in the peripheral circuit, the variable peripheral circuit power voltage unit 113 may adjust a portion of the power supply voltage supplied from the outside to a voltage of 1.0 V and may supply the voltage of 1.5 V, which is not adjusted, and the voltage of 1.0 V, which is adjusted, to each of the plurality of blocks of the peripheral circuit.

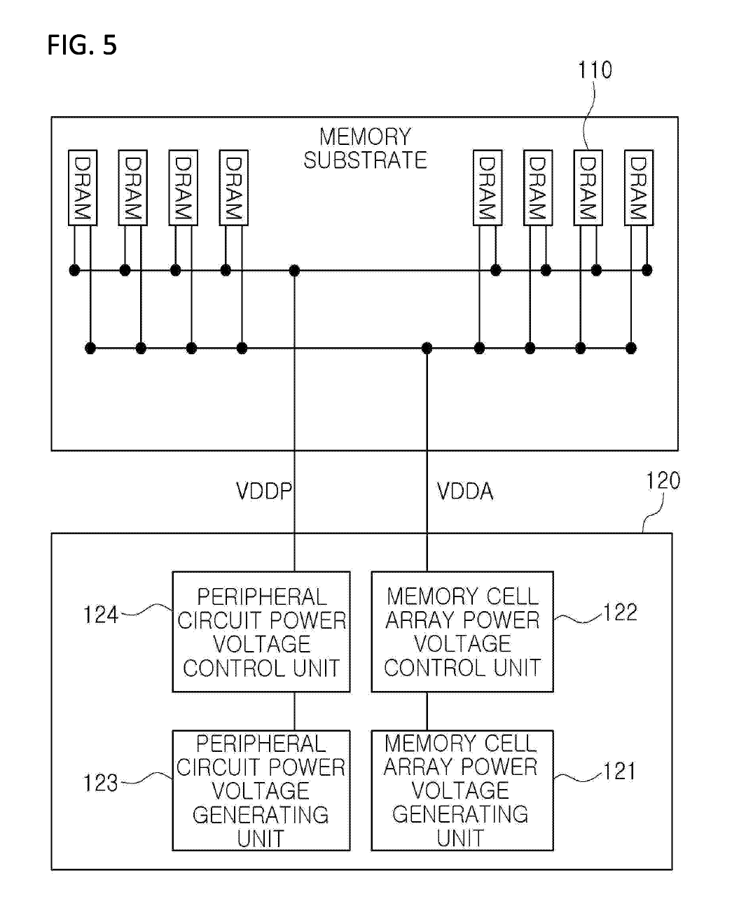

FIG. 5 is a diagram illustrating a configuration of a memory device according to one embodiment of the present invention. As shown in FIG. 5, the memory device 100 according to one embodiment of the present invention may include a memory chip 110 and a power voltage supply unit 120.

Hereinafter, each of components constituting the memory device according to one embodiment of the present invention will be described in detail.

The memory chip 110 included in the memory device according to one embodiment of the present invention may include the memory cell array 111 and the peripheral circuit 112, as shown in FIG. 3.

Further, as shown in FIG. 5, the power voltage supply unit 120 of the memory device according to one embodiment of the present invention may include a memory cell array power voltage generating unit 121 configured to generate a memory cell array power voltage, a memory cell array power voltage control unit 122 connected to the memory cell array and configured to supply the memory cell array with the memory cell array power voltage generated by the memory cell array power voltage generating unit, a peripheral circuit power voltage generating unit 123 configured to generate a peripheral circuit power voltage, and a peripheral circuit power voltage control unit 124 connected to the peripheral circuit and configured to supply the peripheral circuit with the peripheral circuit power voltage generated by the peripheral circuit power voltage generating unit.

That is, when the memory cell array power voltage generating unit 121 generates the memory cell array power voltage, the memory cell array power voltage control unit 122 supplies the memory cell array 111 with the memory cell array power voltage, and when the peripheral circuit power voltage generating unit 123 generates the peripheral circuit power voltage, the peripheral circuit power voltage control unit 124 supplies the peripheral circuit with the peripheral circuit power voltage.

In the memory device according to one embodiment, the memory cell array power voltage VDDA and the peripheral circuit power voltage VDDP may be applied to the memory chip through a power management integrated circuit (PMIC).

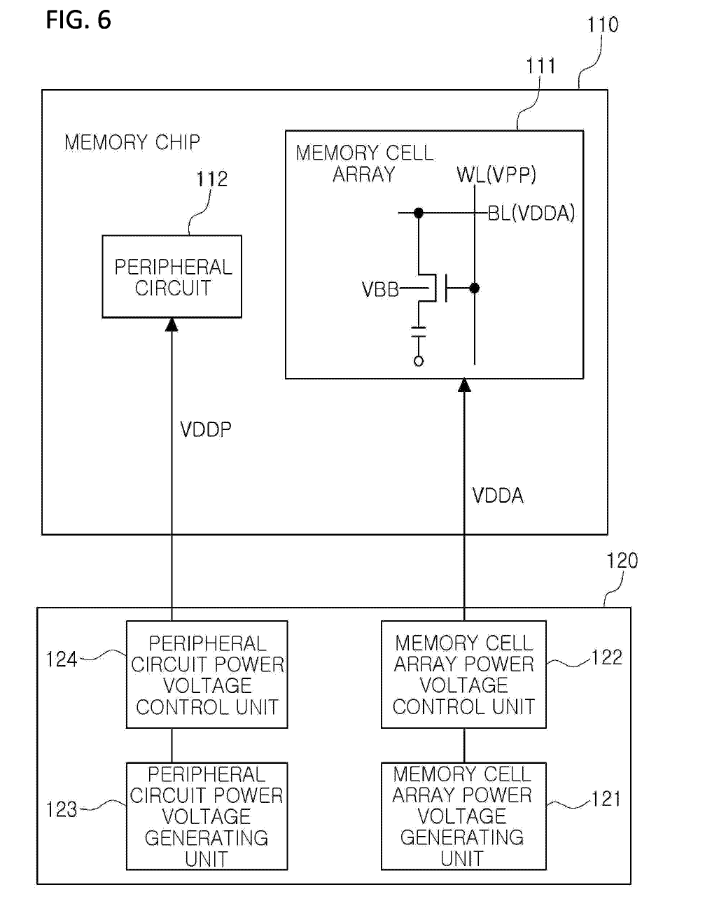

FIG. 6 illustrates a case in which a power voltage is supplied to the memory chip according to one embodiment of the present invention. As shown in FIG. 6, the memory cell array 111 and the peripheral circuit 112 of the memory device according to one embodiment of the present invention are independently connected to the power voltage supply unit 120. That is, the memory cell array 111 may be connected to the memory cell array power voltage control unit 122 to directly receive the power voltage generated in the memory cell array power voltage generating unit 121, and the peripheral circuit 112 may be connected to the peripheral circuit power voltage control unit 124 to directly receive the power voltage generated in the peripheral circuit power voltage generating unit 123.

Thus, the memory device according to one embodiment of the present invention may independently supply the memory cell array power voltage and the peripheral circuit power voltage to the memory cell array and the peripheral circuit, respectively, without having a circuit configured to generate a power voltage in the memory chip, and thus a memory device having various specifications can be implemented.

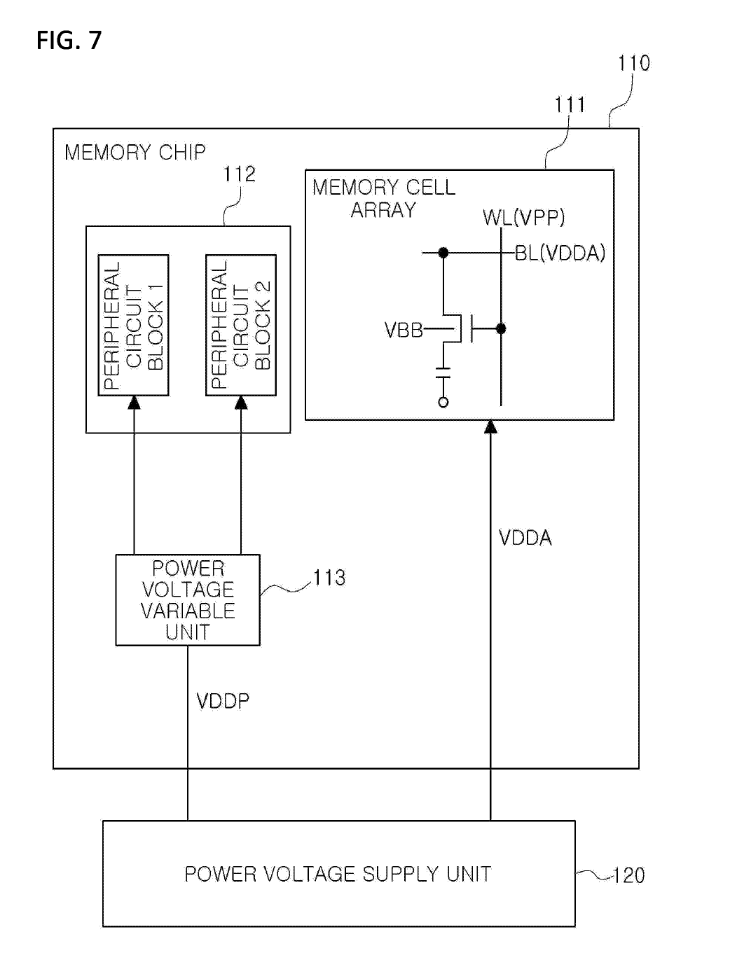

FIG. 7 is a diagram illustrating a configuration of a memory device according to another embodiment of the present invention. As shown in FIG. 7, a peripheral circuit 112 of the memory device according to one embodiment of the present invention may further include a variable peripheral circuit power voltage unit 113 connected between a power voltage supply unit 120 and a peripheral circuit 112 that is configured to adjust a power voltage supplied to the peripheral circuit 112. As described above, the variable peripheral circuit power voltage unit 113 may adjust the peripheral circuit power voltage, which is supplied from the outside, to supply the power voltage to a plurality of peripheral circuit blocks.

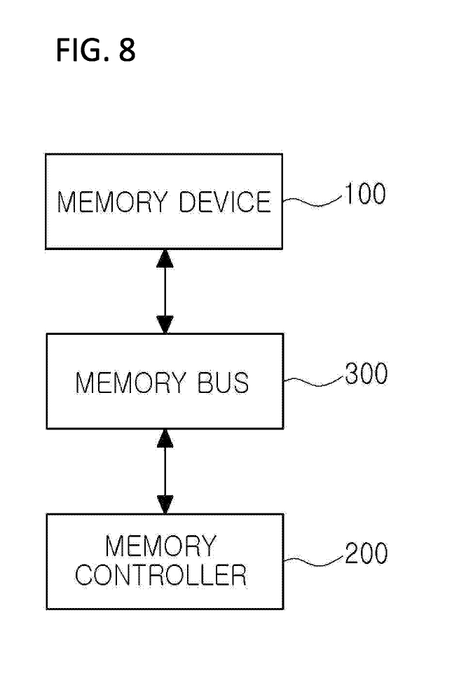

FIG. 8 is a diagram illustrating a configuration of a memory system according to one embodiment of the present invention. As shown in FIG. 8, the memory system according to one embodiment of the present invention may include a memory device 100, a memory controller 200, and a memory bus 300.

As shown in FIGS. 3 to 6, the memory device 100 may include at least one memory chip having a memory cell array configured with an array of memory cells, a peripheral circuit positioned around the memory cell array, and a power voltage supply unit configured to supply a power voltage to the memory cell array and the peripheral circuit, wherein the power voltage supply unit may independently supply the power voltage to the memory cell array and the peripheral circuit.

The memory controller 200 may control a command, a piece of data, and an address which are input to and output from the memory device and may further control a plurality of memory devices. The memory bus 300 may transfer information between the memory device and the memory controller.

The memory system according to one embodiment of the present invention can easily control a power voltage supply at the outside of the memory chip to correspond to various applied electronic products such as a personal computer (PC), a television (TV), a smart phone, and the like.

The present invention is not limited to the above-described exemplary embodiments and the accompanying drawings. It will be apparent to those skilled in the art to which the present invention pertains that substitutes, modifications, and alternations of components according to the present invention can be made without departing from the technical spirit of the present invention.

1. A memory chip comprising:
a memory cell array configured with an arrangement of memory cells; and
a peripheral circuit positioned around the memory cell array and having a power line electrically independent from the memory cell array,
wherein a power voltage is independently and externally supplied to the memory cell array and the peripheral circuit.

2. The memory chip of claim 1, wherein the power voltages at different levels are supplied to the memory cell array and the peripheral circuit.

3. The memory chip of claim 1, wherein the peripheral circuit is divided into one or more blocks according to levels of the power supply voltages used therein.

4. The memory chip of claim 1, further comprising a variable power voltage unit connected to the peripheral circuit and configured to adjust all or a portion of the power voltage supplied to the peripheral circuit to supply the plurality of power voltages to the peripheral circuit.

5. A memory device comprising:
at least one memory chip including a memory cell array configured with an arrangement of memory cells and a peripheral circuit positioned around the memory cell array and having a power line electrically independent from the memory cell array; and
a power voltage supply unit configured to supply a power voltage to the memory cell array and the peripheral circuit,
wherein the power voltage supply unit independently supplies the power voltage to the memory cell array and the peripheral circuit.

6. The memory device of claim 5, wherein the power voltage supply unit supplies power voltages at different levels to the memory cell array and the peripheral circuit.

7. The memory device of claim 5, wherein the power voltage supply unit includes:
a memory cell array power voltage generating unit configured to generate a memory cell array power voltage;
a memory cell array power voltage control unit connected to the memory cell array and configured to supply the memory cell array with the power voltage generated by the memory cell array power voltage generating unit;
a peripheral circuit power voltage generating unit configured to generate a peripheral circuit power voltage; and
a peripheral circuit power voltage control unit connected to the peripheral circuit and configured to supply the peripheral circuit with the power voltage generated by the peripheral circuit power voltage generating unit.

8. The memory device of claim 5, wherein the peripheral circuit is divided into one or more blocks according to a level of the power voltage used therein.

9. The memory device of claim 5, wherein the memory chip further includes a variable power voltage unit connected to the peripheral circuit and configured to adjust all or a portion of the power voltage supplied to the peripheral circuit to supply a plurality of power voltages to the peripheral circuit.

10. A memory system comprising:
a memory device including at least one memory chip having a memory cell array configured with an arrangement of memory cells and a peripheral circuit positioned around the memory cell array and having a power line electrically independent from the memory cell array, and a power voltage supply unit configured to supply a power voltage to the memory cell array and the peripheral circuit, wherein the power voltage is independently and externally supplied to the memory cell array and the peripheral circuit;
a memory controller configured to control a command, a piece of data, and an address which are input to and output from the memory device; and
a memory bus configured to transfer information between the memory device and the memory controller.

11. The memory system of claim 10, wherein the power voltage supply unit supplies power voltages at different levels to the memory cell array and the peripheral circuit.

12. The memory system of claim 10, wherein the power voltage supply unit includes:
a memory cell array power voltage generating unit configured to generate a memory cell array power voltage;
a memory cell array power voltage control unit connected to the memory cell array and configured to supply the memory cell array with the power voltage generated by the memory cell array power voltage generating unit;
a peripheral circuit power voltage generating unit configured to generate a peripheral circuit power voltage; and
a peripheral circuit power voltage control unit connected to the peripheral circuit and configured to supply the peripheral circuit with the power voltage generated by the peripheral circuit power voltage generating unit.

13. The memory system of claim 10, wherein the peripheral circuit is divided into one or more blocks according to a level of the power voltage used therein.

14. The memory system of claim 10, wherein the memory chip further includes a variable power voltage unit connected to the peripheral circuit and configured to adjust all or a portion of the power voltage supplied to the peripheral circuit to supply a plurality of power voltages to the peripheral circuit.

15. The memory system of claim 10, wherein the memory controller controls one or more memory devices identical to the memory device.
